(19) United States
(12) Patent Application Publication
(10) Pub. No.: US 2009/0027421 A1
(43) Pub. Date: Jan. 29, 2009

(54) Computer system with a zooming capability and method

(76) Inventors: Franklin Servan-Schreiber, Paris (FR); Daniel de Fuenmayor, Paris (FR)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,636

(22) Filed: Jul. 25, 2008

Related U.S. Application Data
(60) Provisional application No. 60/935,149, filed on Jul. 27, 2007.

(51) Int. Cl. G09G 5/373; G09G 5/08

(52) U.S. Cl. 345/661

(57) ABSTRACT

The computer system with zoom capability includes a floating zoom button which follows a cursor or may be navigated by a stylus or a finger tip across the display screen of the computer system. The floating zoom button includes a floating zoom “+” button and a floating zoom “−” button where the “+” button locates itself by default under the cursor and a zoom-in function is activated if the user interactive input device is actuated. A computer mouse, a pointing device, a stylus, or a finger tip may be used as the user interactive input arrangement. The cursor may move within the floating zoom button area provided to allow displacement of the cursor between the “+” and “−” buttons without displacement of the location of the floating zoom button. In this manner, the user may opt for the “−” button which represents a zoom-out with a minimization of any effort. By actuating the user interactive input device while the cursor points to the “−” button, a zoom-out action is performed on the display area provided within the floating zoom button area.

### REFERENCE TO RELATED APPLICATIONS

This Utility Patent Application is based on the Provisional Patent Application Ser. No. 60/935,149 filed 27 Jul. 2007.

### FIELD OF THE INVENTION

The subject invention is directed to a system and method for actuation and performing a zoom function, and more in particular to a computer system with a zoom capability which provides access to both “zoom-in” and “zoom-out” functions with the use of a single mouse control button and without the necessity of any keyboard interaction.

The subject invention is also directed to a touch screen computer system with a zoom capability which provides access to both “zoom-in” and “zoom-out” functions merely with the use of a pointing device (stylus) or a finger tip.

In overall concept, the present invention is directed to a computer system provided with a “±” zoom icon on the computer monitor display which is navigated by a pointer across the display screen to an object of interest. The functions of the pointer are either performed by a mouse cursor, or, in the touch screen systems, by a pointing device or a finger tip. The “±” icon is defined as a floating zoom button at the display screen and includes a zoom “+” button and a zoom “−” button. Within the floating zoom button, the cursor (or a pointing device, or a finger tip) may be displaced between the “+” and the “−” zoom buttons without displacement of the location of the floating zoom button. The “+” button locates itself by default under the cursor and a “click” on the “+” icon presented within the floating zoom button provides the zoom-in action of the display area encompassed within the floating zoom button. The user may opt for the “−” button which represents a zoom-out action with a minimization of any effort. “Clicking” the “−” button then performs a zoom-out action on the display area provided within the floating zoom button area.

### BACKGROUND OF THE INVENTION

Zoom capability is an important feature of contemporary computer systems which provides for text or other graphics in a specified window or frame to appear larger on the screen when a zoom-in function is actuated or smaller when a zoom-out action is performed.

Most computer systems with zoom-in and zoom-out functions use two separate control buttons provided on a computer mouse and additionally keyboard interaction is required to be taken by a user. Such prior systems include Photoshop, Google Maps, Zoomify, FlashEarth, Flash web site, and Sachs Fifth Avenue e-Commerce systems. For example, in the FlashEarth, a user actuates the right mouse button to access a dropdown menu with zooming functions and then operates the left button to actuate the desired menu functions. In the Photoshop system, there is a control button on the computer mouse to actuate a zoom-in function, and by concurrently pressing the “CRTL” key on the keyboard, the cursor changes to zoom-out.

In PDF systems, there are three buttons used for Zooming, including zoom-in, zoom-out, and a dynamic zoom tool which zooms-in when moved upward, and zooms-out when moved downward. The PDF dynamic zoom tool does not permit zooming-in on a specific location in a page, rather the content has to be adjusted correctly prior to or post zoom action by using the window scroll bar.

The necessity in all existing zooming computer systems to use either two or three mouse buttons to perform zoom functions, or the concurrent use of the mouse button and the keyboard, or inability to “aim” a specific location of interest on the screen without some manipulation of the content of interest makes it greatly desirable to provide a zooming computer system which would permit a simplified access to both zoom-in and zoom-out functions. Additionally, it would be desirable to provide a simple “targeting” of a specific location subject to zoom merely by navigating the cursor on the screen.

### SUMMARY OF THE INVENTION

It is therefore an object of the present invention to provide a computer system with zooming capability where the access to both zoom-in and zoom-out is attained with the use of a single mouse button and with no keyboard action taken on the part of an operator.

Alternatively, it is an object of the present invention to provide a touch screen computer system with zoom capabilities where both zoom-in and zoom-out functions are achieved with the use of a pointing device (stylus) or a finger tip.

It is another object of the present invention to provide a computer system with zoom capability which allows a user to “aim” at a specific location at the computer display screen for zooming and is operationally actuated by simply navigating the cursor to the target for magnification/reduction.

It is a further object of the present invention to provide a computer system with zoom capability which is provided by positioning a floating zoom button, having “±” zoom areas, on the screen which follows the cursor when the cursor is outside of the “±” icon and which remains immovable when the cursor moves within the boundaries of the floating zoom button between the “+” and “−” zoom areas (buttons). The “+” button locates itself by default under the mouse cursor, and a click on the “+” icon will provide a zoom-in action. The user is also enabled to choose a “-” button representing a zoom-out function by clicking on the “−” button to perform the zoom-out action.

It is an additional object of the present invention to provide a touch screen computer system in which a floating zoom button is navigated across the screen and zoom functions are actuated by manipulating a pointing device or a finger tip.

In one aspect of the present invention, a computer system with zoom capability comprises a computer processing unit, a display screen, a user interactive input device (such as, for example, a computer mouse, or a stylus, or a finger tip, or any type of a pointing arrangement), and a pointer (input device cursor) moving on the display screen in correspondence with displacement (actuation) of the input device.

An important element of the present system is a floating zoom indicia which is displayed on the display screen in an interactive relationship with a pointer, such as, for example, a mouse cursor or another pointing arrangement. The floating zoom indicia (or button) has a boundary encompassing a predetermined area on the display which contains a “+” zoom area (button) and “−” zoom area (button).

In operation, the computer processing unit displaces the floating zoom indicia on the display screen to be displaced responsive to the displacement of the pointer (for example, mouse cursor, stylus or a finger tip) when the pointer is displaced outside a boundary of the floating zoom indicia by a predetermined distance. When the pointer and the floating zoom button attain the object of interest, the pointer is positioned within the boundary of the floating zoom button, and the “+” zoom area places itself by default under the mouse cursor. If zoom-in action is desired such is enabled by actuating the control key on the mouse or by touching the “+” zoom button by a pointing device. Since the pointer moves freely within the boundaries of the floating zoom indicia, if alternatively the zoom-out function is to be chosen, the pointer moves to the “−” zoom area and the zoom-out function is activated by actuation of the control key on the mouse or by a touch of the pointing device.

In the computer system of the present invention, the computer processing unit estimates the separation distance between the pointer and the boundaries of the floating zoom button and moves the latter after the pointer if the separation distance is greater than a predetermined value corresponding to the linear dimension of the floating zoom button. This separation distance is preferably W/2 wherein W is the width of the boundary box surrounding the floating zoom button.

To control the interaction between the floating zoom button and the mouse cursor, the computer processing unit uses a decision block for determining a position of the mouse cursor relative to the boundary of the floating zoom indicia, and further uses a displacement decision block for actuating the displacement of the floating zoom indicia to follow the mouse cursor by a predetermined separation distance therefrom if the mouse cursor is outside the boundary of the floating zoom indicia. The computer processing unit also uses another decision block to determine whether the mouse cursor is aligned with the first or with the second zoom area when the mouse cursor is positioned inside the boundary of the floating zoom indicia, and to activate a zoom action, e.g., the zoom-in or zoom-out efforts for the object of interest in response to a signal output from the another decision block upon actuation of the control button on the mouse.

The object of interest subject to a zoom action may include data representation, text representation, image representation, graphic, etc.

Another aspect of the present invention is directed to a method for performing a zoom action in a computer system which includes the steps of:
coupling a display screen to a computer processing unit,
displaying an object representation on the display screen,
connecting a user interactive input device (for example, a computer mouse) having a control button to the computer processing unit and the display screen,
displaying a pointer (for example, mouse cursor) on the display screen,
displaying a floating zoom indicia (button) on the display screen which includes a boundary (global bounding box) encompassing a predetermined area on the display screen, and a first zoom area and a second zoom area disposed within the boundary,
positioning the pointer outside the boundary of the floating zoom indicia, and
displacing the pointer on the display screen by moving the user interactive input device, thereby causing a corresponding displacement of the floating zoom indicia following the pointer by a predetermined separation distance therefrom.

The method further has the steps of:
upon reaching the object of interest on the display screen, positioning the pointer inside the boundary of the floating zoom indicia. At this instant, the floating zoom indicia is aligned with the object representation on the display screen, and the first zoom area is aligned with the pointer by default, and
actuating the user interactive input device if the pointer is aligned with the zoom area intended.

If, however, an opposite zoom action is desired, the pointer is displaced within the floating zoom indicia to another zoom area, and the user interactive input device is actuated to cause a required zoom action.

The method further includes the steps of:
controlling an information flow in the computer processing unit to determine whether the pointer is aligned with the first or second zoom area if the pointer is situated within the boundary of the floating zoom indicia, and

actuating a zoom action corresponding to a respective one of the first and second zoom areas aligned with the pointer upon actuation by a user of the control button on the user interactive input device.

The computer processing unit is configured to hold the floating zoom indicia immovably on the display screen when the pointer moves within the boundary of the floating zoom indicia.

The method further includes the steps of controlling the information flow to move the floating zoom indicia responsive to the displacement of the pointer when the pointer is displaced outside the boundary of the floating zoom indicia by a distance greater than a predetermined distance which is related to the dimensions of the floating zoom button.

These and other features and advantages of the present invention will become apparent after reading a further description of the preferred embodiment in conjunction with the Patent Drawings.

### BRIEF DESCRIPTION OF THE DRAWINGS

FIG. 1 is a schematic representation of the computer system having the zoom capabilities of the present invention;

FIG. 2 is a schematic representation of the floating zoom button showing the “+” and “−” icons formed as visible features on the floating zoom button of the present invention;

FIGS. 3A-3B show schematically two modes of interactive relationship between the floating zoom button and the mouse cursor; wherein, FIG. 3A shows the floating zoom button following the cursor on the display screen when the separation distance therebetween is greater than W/2, and FIG. 3B shows the cursor within the boundary of the floating zoom button; and

FIG. 4 is a computer flow diagram showing the information flow for displacement of the floating zoom button as performed in the computer processing unit of the present invention.

### DETAILED DESCRIPTION OF THE PREFERRED EMBODIMENTS

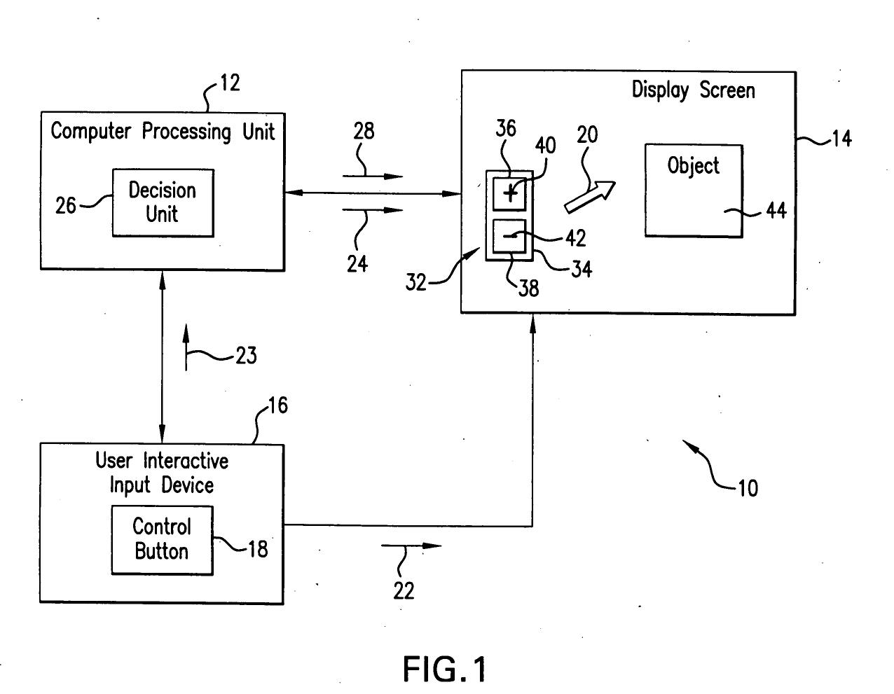

Referring to FIG. 1, the computer system 10 of the present invention includes a Computer Processing Unit 12, and a monitor display screen (or a touch screen) 14 coupled to the Computer Processing Unit 12 and controlled therefrom. The computer system of the present invention may include a computer system of any complexity or capability, and may be configured for various purposes, including for example general purposes computers, Personal Digital Assistants (PDAs), iPhones, touch screen systems, etc., provided the computer system permits user-visual display interaction and has zoom capabilities. The computer system 10 further includes a user interactive input device 16, such as, for example, a computer mouse. When a touch screen system is used, a pointing device (stylus) or a finger tip may be used as the user interactive input device 16.

For the purposes of an example only, and not to restrict the scope of protection of the present invention to any particular implementation thereof, the following description will be directed to the computer system 10 using the user interactive input device implemented as a computer mouse. The computer mouse has one or more control buttons . However, only a single control button 18 on the computer mouse 16 is sufficient for the zooming techniques of the present computer system 10. A pointer (or mouse cursor) 20 is displayed on the display screen 14 as is customary for such general purpose computers.

When the user interactive input device 16 is displaced, the cursor 20 is also displaced on the display screen 14 in accordance with a displacement command 22 transmitted by the user interactive input device 16 to the display screen. In general, the computer mouse 16 issues a displacement command 23 which is “read” by the Computer Processing Unit 12 and is processed therein for the purposes of generating a cursor displacement command 24 to be further transmitted to the display screen 14.

The Computer Processing Unit 12 also receives the signal from the control button 18 for processing of the same and generates a signal 28 corresponding to the control button actuation state which is transmitted to the display screen 14.

An algorithm, e.g. a decision unit 26 in the Computer Processing Unit 12 controls the information flow in the Computer System 10 and basically controls all aspects of the zoom capabilities of the present invention. Specifically, as a part of the algorithm 26, the computer processing unit 12 monitors and controls the communication of the signal 28 corresponding to the state of the control button 18 to the display screen 14 for performing a zoom action as will be presented in the following paragraphs.

A floating zoom indicia 32 (also intermittently referred to herein as a floating zoom button or icon) is displayed on the display screen 14 for the purposes of facilitating the zoom capability of the present computer system. As best shown in FIGS. 1, 2 and 3A-3B, the floating zoom button 32 includes a global bounding box 34, also referred to herein as a boundary, which encompasses a predetermined area on the display screen 14. The floating zoom button 32 includes a zoom “+” button 36 and a zoom “−” button 38 aligned in a predetermined relation each to the other, preferably, in a vertical direction. Alternatively (although not shown), the “+” and “−” zoom buttons 36, 38 may be aligned in a horizontal direction.

The zoom “+” button 36 includes the “+” icon 40. The zoom “−” button 38 includes the “−” icon 42. Although shown as having “+” icon 40 and “−” icon 42, the floating zoom indicia 32 may have other alternative representations of the zoom-in and zoom-out actions.

The computer system 10 is configured in such a way that when the mouse cursor 20 is moved outside the floating zoom button 32 a distance greater than the linear dimensions global bounding box 34, the floating zoom button 32 follows the mouse cursor 20 at a distance greater than the width W of the floating global bounding box 34 divided by two (W/2), as presented in FIG. 3A. Alternative separating distances between the mouse cursor 20 and the floating zoom indicia 32 are also contemplated in the scope of the present invention.

Once the mouse cursor, along with the floating zoom indicia 32, reaches an object representation 44 on the display screen 14, as best shown in FIG. 3B, for the purposes of performing a zoom action (e.g., zoom-in or zoom-out) at a predetermined location on the object representation 44, the mouse cursor 20 is positioned inside the floating zoom button 32, specifically inside the global bounding box 34, and is free to move within the boundaries of the floating zoom button 32 without displacement of the location of the floating zoom button 32.

In this interaction regime between the mouse cursor 20 and the floating zoom button 32, e.g. once the mouse cursor 20 is inside the floating zoom button 32, the floating zoom “+” button 36 locates or positions itself by default under the mouse cursor 20 and a click on the “+” icon (by actuating the control button 18), will have the zoom-in action directed to the object representation 44.

If desired, the user may opt for the “−” icon 42 which represents a zoom-out action with a minimization of the effort. To attain the zoom-out of the object representation 44, the mouse cursor 20 is displaced from the “+” zoom button 36 to the “−” zoom button 38, specifically to the “−” icon 42 therein, and upon actuation of the control button 18 on the computer mouse 16, the system performs a zoom-out action on the object representation 44, specifically on the portion of the object representation 44 provided within the area covered by the floating zoom button 32. In this manner, both a zoom-in and zoom-out action uses a single mouse button 18, with no additional action of the keyboard required, in order to switch between the zoom-in and zoom-out actions.

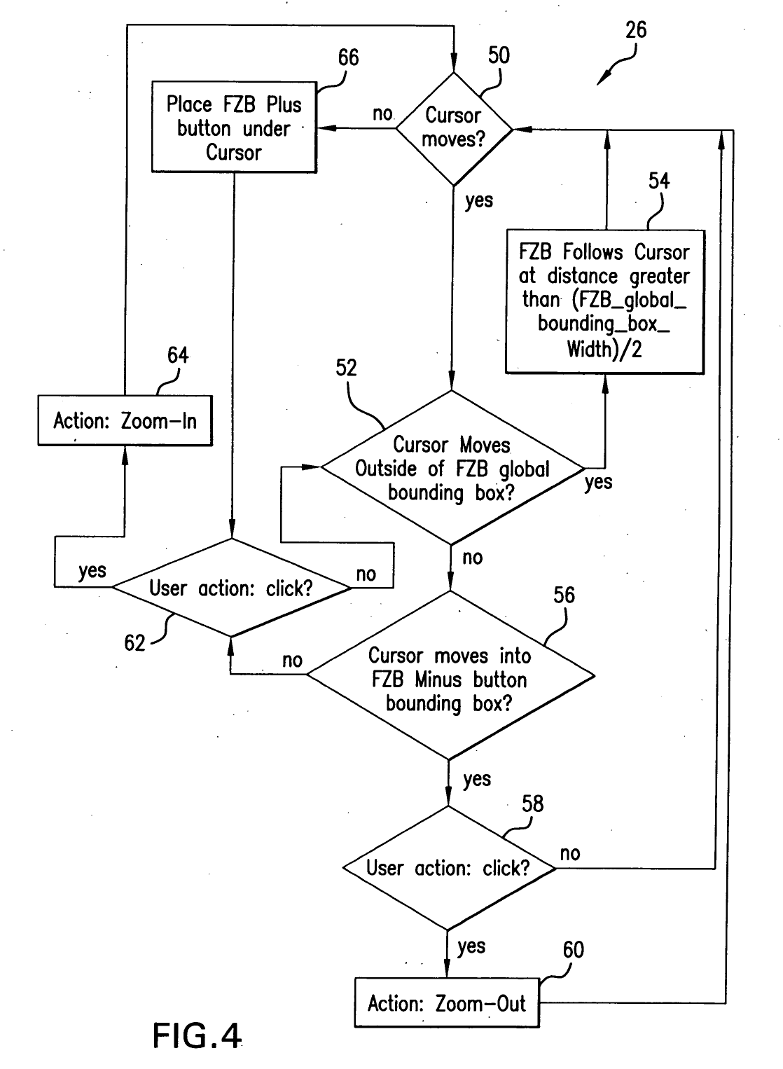

Referring to FIGS. 1 and 4, the operation of the computer system 10 is controlled in accordance with the algorithm 26, also referred to herein as a decision unit 26, which processes data and issues instructions to operate the computer system 10, and specifically for performing the zoom-in and zoom-out functions. The decision unit 26, as best presented in FIG. 4, includes a decision block 50 “Cursor Moves?” provided to determine whether the mouse cursor 20 has been displaced.

If the mouse cursor has been displaced, the data flows to decision block 52 “Cursor Moves Outside of FZB global bounding box?” where the processing unit 12 determines whether the mouse cursor moves external to the floating zoom button 32, specifically, external to the global bounding box 34.

If the mouse cursor 20 has moved external to the global bounding box 34, the floating zoom button 32 is then directed to follow the mouse cursor 20 on the display screen 14 at a distance being greater than a predetermined separation distance, preferably the distance greater than the width of W of the global bounding box 34 divided by 2. This action is performed in the block 54 “FZB Follows Cursor at distance greater than FZB global bounding box width/2”. Information then flows back to the decision block 50 to determine whether the mouse cursor has further been displaced.

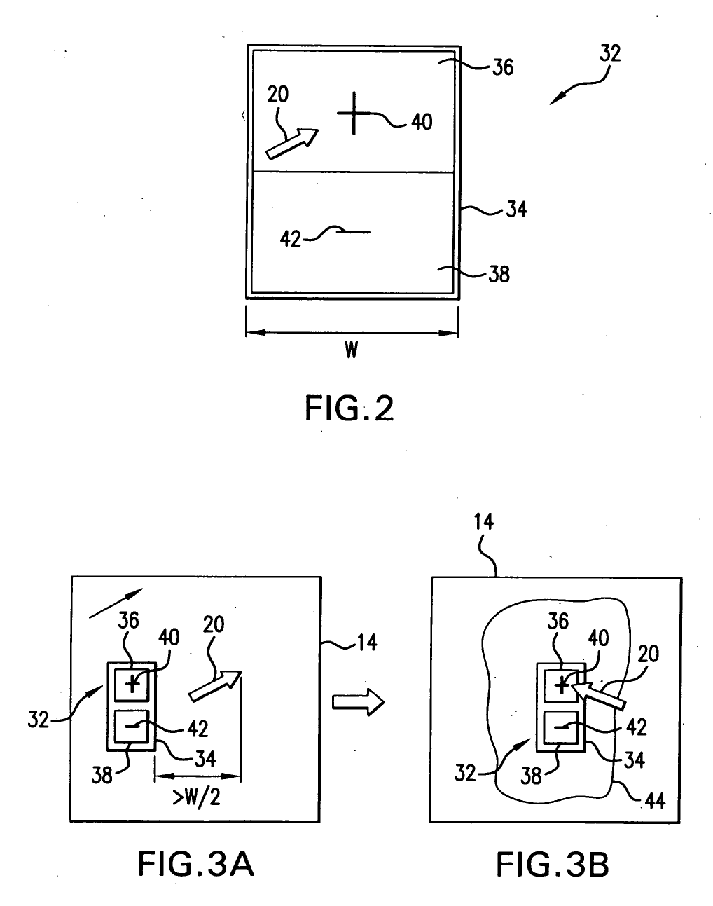

If in the decision block 52, the mouse cursor 20 has not been displaced external to the global bounding box 34 of the floating zoom button 32, the information flows to decision block 56 “Cursor Moves into FZB-button bounding box?”, where it is determined whether the mouse cursor 20 has been displaced into the “−” button 38. The system doesn't determine whether the mouse cursor has been aligned with the “+” button 36 since whenever the cursor is inside the floating zoom indicia 32, the floating zoom “+” button 36 locates itself by default under the mouse cursor 20, as shown in FIGS. 2 and 3B.

If in block 56, the system determines that the mouse cursor has moved into the “−” zoom button 38, then the user has the option in the decision block 58 to “click” for zoom-out of the image of interest in block 60 by actuating the control button 18 on the computer mouse 16. If there is no actuation of the control button 18, then the information flow is passed back to the decision block 50.

If in the block 56 it is determined that the mouse cursor 20 is not displaced into the “-” zoom button 38, the logic flows to block 62 “User Action: click?” to make a decision for the user to “click” the mouse control button 18. If the control button 18 is not actuated, then the information flows to the decision block 52 for determination whether the mouse cursor 20 has been displaced outside of the global bounding box 34 of the floating zoom indicia 32.

If, however, in block 62, the control button 18 is actuated, the information flows to the information block 64 “Action: Zoom-In” where there is a zoom-in action taken and information then flows back to the decision block 50 for decision as to whether the mouse cursor 20 has been displaced.

If in the decision block 50, the cursor 20 has not been displaced, then the zoom “+” button 36 is placed under the mouse cursor and-once again user action is determined in decision block 62 for either the mouse control button 18 to be actuated or no actuation is taken for passage of the information back to the decision block 52. In this manner, the zoom-in and zoom-out functions are accessed by the operator using a single mouse control button 18 with no interaction with a keyboard.

It is clear that the present system 10 allows the user to “aim” at a specific area of the object representation 44 on the display screen 14 for zoom-in or zoom-out by mere positioning of the mouse cursor and the floating zoom button 32 on the target area for magnification (or reduction) of the area of the object representation encompassed within the global bounding box (boundary) 34 of the floating zoom button 32, when the user clicks on the “+” or “−” icons 40 or 42.

Although this invention has been described in connection with specific forms and embodiments thereof, it will be appreciated that various modifications other than those discussed above may be resorted to without departing from the spirit or scope of the invention as defined in the appended Claims. For example, equivalent elements may be substituted for those specifically shown and described, certain features may be used independently of other features, and in certain cases, particular applications of elements may be reversed or interposed, all without departing from the spirit or scope of the invention as defined in the appended Claims.

What is claimed is:

1. A computer system with a zooming capability, comprising:
a computer processing unit;
a display screen operably coupled to said computer processing unit to display an object representation thereon;
a user interactive input device operably connected to said display screen;
a pointer moving on said display screen responsive to a displacement of said user interactive input device;
a floating zoom indicia displayed on said display screen in interactive relationship with said pointer, said floating zoom indicia having a boundary encompassing a predetermined area of said display screen and a first and second zoom areas disposed within said boundary of said floating zoom indicia;
wherein said computer processing unit displaces said floating zoom indicia on said display screen to proceed responsive to said pointer displacement when said pointer is displaced outside said floating zoom indicia a predetermined distance from said boundary thereof; and
wherein, when said pointer is located inside said boundary of said floating zoom indicia, said computer processing unit actuates a first zoom action affecting a portion of said object representation on said display screen within said boundary upon actuation of interaction of said user interactive input device with said first zoom area, and actuates a second zoom action affecting the portion of said object representation on said display screen within said boundary upon actuation of interaction of said user interactive, input device with said second zoom area.

2. The computer system with a zooming capability as recited in claim 1, wherein said floating zoom indicia includes an icon having a global bounding box containing said first and second zoom areas.

3. The computer system with a zooming capability as recited in claim 1, wherein actuation of said first and second zoom areas result in “zoom-in” and “zoom-out” actions, respectively, affecting said object representation.

4. The computer system with a zooming capability as recited in claim 2, wherein said first and second zoom areas are represented as a “+” and a “−” zoom buttons on said display unit, respectively.

5. The computer system with a zooming capability as recited in claim 4, wherein said “+” and “−” zoom buttons are aligned within said global bounding box in a vertical relationship each to another.

6. The computer system with a zooming capability as recited in claim 1, wherein said pointer moves within said boundary of said floating zoom indicia while the same remains immovable on said display screen.

7. The computer system with a zooming capability as recited in claim 2, wherein said predetermined distance is greater than a linear dimension W of said global bounding box.

8. The computer system with a zooming capability as recited in claim 7, wherein said floating zoom icon follows said pointer by a separation distance greater than W/2.

9. The computer system with a zooming capability as recited in claim 1, wherein for said first and second zoom actions directed towards said object representation, said first and second zoom areas, respectively, are aligned with said portion of said object representation.

10. The computer system with a zooming capability as recited in claim 1, wherein said user interactive input device includes an input arrangement selected from the group consisting of a computer mouse, a pointing device, a stylus, and a finger tip.

11. The computer system with a zooming capability as recited in claim 1, wherein said computer processing unit further includes:
a first decision block determining a position of said pointer relative to said boundary of said floating zoom indicia,
a displacement decision unit actuating the displacement of said floating zoom indicia to follow said pointer a predetermined separation distance therefrom if said pointer is outside said boundary,
a second decision block determining whether said pointer is aligned with said first or said second zoom area, if said pointer is situated inside said boundary of said floating zoom indicia, and
a zoom action actuating unit actuating a respective one of a “zoom-in” action or a “zoom-out” action directed to said object representation responsive to a signal output from said second decision block.

12. The computer system with a zoom capability as recited in claim 1, wherein said object representation is selected from the group consisting of: data, text, image, and graphic.

13. A method for performing a zoom action in a computer system, comprising the steps of:
coupling a display screen to a computer processing unit;
displaying an object representation on said display screen;
connecting a user interactive input device to said display screen;
displaying a pointer on said display screen;
displaying a floating zoom indicia on said display screen, said floating zoom indicia including a boundary encompassing a predetermined area on said display screen, and having a first zoom area and a second zoom area disposed within said boundary;
positioning said pointer outside said boundary of said floating zoom indicia, and displacing said pointer on said display screen by actuating said user interactive input device, thereby causing a corresponding displacement of said floating zoom indicia following said pointer a predetermined distance therefrom;
positioning said pointer inside the boundary of said floating zoom indicia when said floating zoom indicia is aligned with said object representation on said display screen;
displacing said pointer within said boundary of said floating zoom indicia to align said pointer with either of said first and second zoom area; and
actuating said user interactive input device, thereby causing a zoom action directed towards said object representation corresponding to said first or second zoom area of said floating zoom indicia.

14. The method for performing a zoom action in a computer system as recited in claim 13, further comprising the steps of:
actuation of said user interactive input device to result in a “zoom-in” action when said pointer is aligned with said first zoom area of said floating zoom indicia, and
actuation of said user interactive input device to result in a “zoom-out” action when said pointer is aligned with said second zoom area of said floating zoom indicia.

15. The method for performing a zoom action in a computer system as recited in claim 13, further comprising the steps of:
determining, in said computer processing unit, a position of said pointer relative to said boundary of said zoom floating indicia, and
issuing a command to displace said floating zoom indicia after said pointer if said pointer is positioned outside said boundary.

16. The method for performing a zoom action in a computer system as recited in claim 13, further comprising the steps of:
determining, in said computer processing unit, whether said pointer is aligned with said first or said second zoom area if said pointer is situated within said boundary of said floating zoom indicia, and
issuing a command to actuate a zoom action corresponding to a respective one of said first and second zoom areas aligned with said pointer upon actuation of said user interactive input device.

17. The method for performing a zoom action in a computer system as recited in claim 13, wherein said computer processing unit holds said floating zoom indicia immovable on said display screen when said pointer moves within said boundary of said floating zoom indicia.

18. The method for performing a zoom action in a computer system as recited in claim 13, wherein said computer processing unit controls displacement of said floating zoom indicia relative to said pointer on said display screen.

19. The method for performing a zoom action in a computer system as recited in claim 18, wherein said predetermined separation distance is a function of a linear dimension of said boundary of said floating zoom indicia.

20. A computer system with a zoom capability, comprising:
a floating zoom icon displayed on a display screen and including a “zoom-in” and “zoom-out” buttons in said floating zoom icon,
a mouse cursor displayed on said display screen and moving therealong in accordance with position of a computer mouse, and
a control button on said computer mouse,
wherein, upon said floating zoom button is aligned with an object of interest on said display screen by following after said mouse cursor, said control button on said computer mouse is actuated to cause a respective zoom action corresponding to said “zoom-in” or “zoom-out” buttons pointed to by said mouse cursor.
